(19) United States
(12) Patent Application Publication
(10) Pub. No.: US 2007/0118241 A1
(43) Pub. Date: May 24, 2007

(54) Shake Jamming Portable Media Player

(75) Inventor: Louis B. Rosenberg, Pismo Beach, CA (US)

Correspondence Address: LAW OFFICE OF PHILIP A STEINER, 846 HIGUERA STREET, SUITE 4, SAN LUIS OBISPO, CA, 93401, US

(73) Assignee: OUTLAND RESEARCH, LLC, Pismo Beach, CA (US)

(21) Appl. No.: 11/555,784

(22) Filed: Nov. 2, 2006

Related U.S. Application Data
(63) Continuation-in-part of application No. 11/539,598, filed on Oct. 6, 2006.
(60) Provisional application No. 60/751,267, filed on Dec. 16, 2005.

(51) Int. Cl. G06F 17/00

(52) U.S. Cl. 700/94

(57) ABSTRACT

An apparatus, method and computer program product are provided which establishes a shake jamming portable media player in which a user can listen to a playing musical media file while simultaneously incorporating audio representations of percussion instrument sounds into an audio output stream by physically shaking the portable media player. In response to the physical shaking, the portable media player generates percussion audio signals which are mixed with an audio signal stream of a currently playing musical media file and output to the user. The shake jamming portable media player includes a processor, a memory functionally coupled to the processor, a motion sensor functionally coupled to the processor and configured to detect manual shaking motions imparted by a user on the portable media player, an instrument accompaniment program operatively loadable into the memory which includes instructions executable by the processor to cause a musical media file to be accessed from the memory and be currently played; identify a characteristic shake event from the detected manual shaking motions; generate an audio representation of an audio signal representing a striking or shaking sound of a percussion instrument in dependence on the identified characteristic shake event; mix the generated audio representation of the audio signal with an audio signal stream of the currently playing musical media file and output a resulting audio mixture to the user in near real-time relative to the identified characteristic shake event.

### CROSS-REFERENCE TO RELATED APPLICATIONS

This application is a non-provisional application claiming benefit and priority under 35 U.S.C. § 119(e) from applicant's co-pending U.S. provisional application Ser. No. 60/751,267, filed on Dec. 16, 2005 to a common assignee and the instant inventor;

this application is also a continuation-in-part of co-pending U.S. patent application Ser. No. 11/539,598 filed on Oct. 6, 2006;

this application is also a related application of co-pending U.S. patent applications Ser. Nos. 11/461,375 filed on Jul. 31, 2006; 11/267,079 filed on Nov. 3, 2005; 11/246,050 filed on Oct. 7, 2005; 11/466,381 filed on Aug. 22, 2006; 11/285,534 filed on Nov. 22, 2005; and 11/427,320 filed on Jun. 28, 2006, all to a common assignee and the instant inventor; all of the aforementioned patents applications are hereby incorporated by reference in their entirety.

### FEDERALLY SPONSORED RESEARCH AND DEVELOPMENT

Not Applicable

### REFERENCE TO A MICROFICHE APPENDIX

Not Applicable

### FIELD OF INVENTION

The present inventive embodiments relates generally to portable media players and more specifically to shake-responsive instrument accompaniment capabilities for generating and outputting one or more audio representations of percussion instruments.

### BACKGROUND

Electronic Media Players have become popular personal entertainment devices due to their highly portable nature and interconnectivity with existing computer networks, for example the Internet. The accessibility and simplicity in downloading music and other electronic media continues to fuel the popularity of these devices as is exemplified by Apple Computer, Inc.'s highly successful iPod (TM) portable media player. Recent models also allow for the storage and display of personal photos allowing users to carry about a photo album stored in memory of the portable media player. Other manufacturers have competing Media Players offering various functionalities and file playing compatibilities in an effort to differentiate their products in the marketplace.

As discussed in Apple Computer, Inc., patent application, US 2004/0224638 A1, Ser. No. 10/423,490 to Fadell, et al., which is herein incorporated by reference in its entirety; an increasing number of consumer products are incorporating circuitry to play musical media files and other electronic media.

For example, many portable electronic devices such as cellular telephones and personal digital assistants (PDAs) include the ability to play electronic musical media in many of the most commonly available file formats including MP3, AVI, WAV, MPG, QT, WMA, AIFF, AU, RAM, RA, MOV, MIDI, etc. In the relevant art, portable media players enable users to select media items either manually from memory and/or provide user configurable playlists by which media items may be selected automatically from the memory and outputted to the user.

The portable media players of the relevant art enable users to listen to music as digital audio files and/or as part of digital video files, selecting media items from memory and playing the media files such that the audio content can be listened to through headphone or speakers. Such listening activities however are entirely passive, relegating the user to being a listener of the music content but does not allow the user to generate his or her own musical content through the portable media player. Thus, there is a need in the relevant art to allow the user to actively participate in the musical output using a simple and convenient mechanism coupled to the portable media player. More specifically, what is needed is a portable media player that enables a user to both listen to musical media content and generate percussion instrument audio sound representations in response to natural and intuitive manual manipulations of the handheld casing of the portable media player.

### SUMMARY

The various exemplary embodiments described herein address the limitations in the relevant art and provides mechanisms which allows a user to perform “shake jamming” in which a user can cause a portable media player to produce audio representations of musical instrument accompaniment sounds by manually shaking a portable media player while playing a musical media file. Each musical instrument accompaniment sound representation is produced in near real-time with a characteristic shake event imparted by the user and is output in audio combination with the playing musical media file. In this way a user can listen to the musical media file while selectively generates along with the playing music, the instrument sounds generally being percussion instrument sounds output in response to each shake event imparted by the user. The ability to use a portable media player and not just as a musical playing device but as a shake-responsive instrument accompaniment device is referred to herein as “shake jamming” on a portable media player which is described in the various exemplary embodiments provided herein.

In an exemplary apparatus embodiment, a shake jamming portable media player is provided. This exemplary apparatus comprises; a processor; a memory functionally coupled to the processor; a motion sensor functionally coupled to the processor and configured to detect manual shaking motions imparted by a user on the portable media player; an instrument accompaniment program operatively loaded into the memory including instructions executable by the processor to; cause a musical media file to be accessed from the memory and currently played to the user; identify a characteristic shake event from the detected manual shaking motions; generate an audio signal representing a striking or shaking sound of a percussion instrument in dependence on the identified characteristic shake event; mix the generated audio signal with an audio stream of the currently playing musical media file; and, output a resulting audio mixture to the user in near real-time relative to the identified characteristic shake event.

In a first related exemplary apparatus embodiment, the motion sensor is physically coupled to the portable media player.

In a second related exemplary apparatus embodiment, the audio signal is generated for each identified characteristic shake event.

In a third related exemplary apparatus embodiment, an acoustical characteristic of the generated audio signal is dependent on one of; a magnitude of the identified characteristic shake event, a time duration of the identified characteristic shake event and any combination thereof.

In a fourth related exemplary apparatus embodiment, the acoustical characteristic is one of; volume, decay, attack and resonance.

In a fifth related exemplary apparatus embodiment, the volume is dependent upon the magnitude of the identified characteristic shake event.

In a sixth related exemplary apparatus embodiment, the decay is dependent upon the time duration of the identified characteristic shake event.

In a seventh related exemplary apparatus embodiment, the attack is dependent upon the magnitude of the identified characteristic shake event.

In an eighth related exemplary apparatus embodiment, the resonance is dependent upon one of; the magnitude, the time duration and any combination thereof of the identified characteristic shake event.

In a ninth related exemplary apparatus embodiment, the generated audio signal is contingent upon the magnitude of the identified characteristic shake event.

In a tenth related exemplary apparatus embodiment, the generated audio signal is a striking or shaking sound representation of one of; a drum, a cymbal, a triangle, a maraca, a bell, a tambourine and any combination thereof.

In an eleventh related exemplary apparatus embodiment, the instrument accompaniment program further includes instructions to output a visual image of the percussion instrument corresponding to the current striking or shaking sound representation.

In a twelfth related exemplary apparatus embodiment, the instrument accompaniment program further includes instructions executable by the processor to generate a first audio signal if the magnitude of the identified characteristic shake event is below a predefined threshold and generate a second audio signal if the magnitude of the identified characteristic shake event is equal to or greater than the predefined threshold.

In a thirteenth related exemplary apparatus embodiment, the first audio signal is a striking or shaking sound representation of a drum and the second audio signal is a striking or shaking sound representation of a cymbal.

In a fourteenth related exemplary apparatus embodiment, the characteristic shake event corresponds with the user imparting a single up-down motion generally in parallel to a long axis of the portable media player.

In a fifteenth related exemplary apparatus embodiment, the characteristic shake event is identified based at least in part upon the motion sensor data exceeding both a positive and negative magnitude threshold within a predefined timeframe.

In an exemplary methodic embodiment, a shake jamming portable media player is provided. This exemplary methodic embodiment comprises; functionally coupling a motion sensor to a processor associated with the portable media player; configuring the motion sensor to detect manual shaking motions imparted by a user on the portable media player; operatively loading into a memory coupled to the processor an instrument accompaniment program including instructions executable by the processor for; causing a musical media file to be accessed from the memory and currently played; identifying the imparted characteristic shake event from the manual shaking motion signals; generating an audio signal representing a striking or shaking sound of a percussion instrument in dependence on the identified characteristic shake event; mixing the generated audio signal with an audio stream of the currently playing musical media file; and outputting a resulting audio mixture to the user in near real-time relative to the identified characteristic shake event.

In a first related exemplary methodic embodiment, the instrument accompaniment program further includes instructions executable by the processor for controlling an acoustical characteristic of the generated audio signal in dependence on one of; a magnitude of the identified characteristic shake event, a time duration of the characteristic shake event and any combination thereof.

In a second related exemplary methodic embodiment, the acoustical characteristic is one of, volume, decay, attack and resonance.

In a third related exemplary methodic embodiment, the instrument accompaniment program further includes instructions executable by the processor for controlling the decay in dependence upon the time duration of the identified characteristic shake event.

In a fourth related exemplary methodic embodiment, the instrument accompaniment program further includes instructions executable by the processor for controlling the attack in dependence upon the magnitude of the identified characteristic shake event.

In a fifth related exemplary methodic embodiment, the instrument accompaniment program further includes instructions executable by the processor for generating a first audio signal if the magnitude of the identified characteristic shake event is below a predefined threshold and generating a second audio signal if the magnitude of the identified characteristic shake event is equal to or greater than the predefined threshold.

In a sixth related exemplary methodic embodiment, the first audio signal is a striking or shaking sound representation of a drum and the second audio signal is a striking or shaking sound representation of a cymbal.

In an exemplary computer program product (CPP) embodiment, a CPP for a shake jamming interface embodied in a tangible form comprising instructions executable by a processor associated with a portable media player is provided. This exemplary CCP embodiment comprises the instructions executable by the processor to; cause a musical media file to be accessed from a memory coupled to the processor; cause the accessed musical media file to be currently played; identify a user imparted characteristic shake event from detected manual shaking motion signals received from a motion sensor functionally coupled to the processor; generate an audio signal representing a striking or shaking sound of a percussion instrument in dependence on the identified characteristic shake event; mix the generated audio signal with an audio stream of the currently playing musical media file; and output a resulting audio mixture to the user in near real-time relative to the identified characteristic shake event.

In a first related exemplary CPP embodiment, the program further includes instructions executable by the processor to output a first audio signal if the magnitude of the identified characteristic shake event is below a predefined threshold and output a second audio signal if the magnitude of the identified characteristic shake event is equal to or greater than the predefined threshold.

In a second related exemplary CPP embodiment, the first audio signal is a striking or shaking sound representation of a drum and the second audio signal is a striking or shaking sound representation of a cymbal.

In a third related exemplary CPP embodiment, the program further includes instructions executable by the processor for controlling an acoustical characteristic of the output in dependence on one of; a magnitude of the identified characteristic shake event, a time duration of the characteristic shake event and any combination thereof.

In a fourth related exemplary CPP embodiment, the acoustical characteristic is one of; volume, decay, attack and resonance.

In a fifth related exemplary CPP embodiment, the tangible form is one of; a logical media, a magnetic media and an optical media.

The various exemplary apparatus, methodic and computer program product embodiments described above are provided in related exemplary numeric embodiments for convenience only. No limitation to the various exemplary embodiments disclosed is intended.

### BRIEF DESCRIPTION OF DRAWINGS

The features and advantages of the various exemplary embodiments will become apparent from the following detailed description when considered in conjunction with the accompanying drawings. Where possible, the same reference numerals and characters are used to denote like features, elements, components or portions of the various inventive embodiments. It is intended that changes and modifications can be made to the described embodiment without departing from the true scope and spirit of the subject inventive embodiments as generally defined by the claims.

FIG. 1—depicts a generalized and exemplary block diagram of a portable media player.

FIG. 2—depicts an exemplary signal trace of a motion sensor.

FIG. 3—depicts a generalized and exemplary block diagram of an embodiment of the portable media player.

FIG. 4—depicts an exemplary functional diagram of an instrument accompaniment program.

FIG. 5—depicts an exemplary process flow chart of the various exemplary embodiments.

### DETAILED DESCRIPTION

Portable media players enable users to listen to music as digital audio files accessed and played from memory. Such listening activities however are entirely passive, relegating the user to being a mere listener of the musical content but does not allow the user to generate his or her own musical accompaniment along with the playing musical media file. The various inventive embodiments presented herein addresses this need by turning a portable media player into an instrumental accompaniment device with which a user can not only listen to music, but also can generate audio representations of musical instrument accompaniment sounds by manually shaking the portable media player as a means of generating audio representations of musical instrument accompaniment sounds that are played in audio combination with a playing musical media file. Even more specifically, various exemplary embodiments described herein enable the sound of shaking or striking a percussion instrument to be generated in response to characteristic shake event(s) imparted by a user to be output in audio combination with a playing musical media file. In various exemplary embodiments, the musical quality of each output audio signal is dependent upon a magnitude and/or duration of the characteristic shake event to which it is responsive. In this way, listening to music with a portable media player is not a passive activity but may actively involve the user providing his or her own instrumental accompaniment to the musical content by simply shaking the portable media player.

The various exemplary embodiments described herein provide an apparatus, method and computer program product which allows a user to selectively cause audio representations of percussion instrument sounds to be generated and mixed with a currently playing audio stream by simply imparting a physical shaking motion upon a portable media player. More specifically, the various exemplary embodiments described herein enables the user to selectively produce audio representations of musical instrument accompaniment sounds by manually shaking a portable media player that is playing a current musical media file. The audio representations of the musical instrument accompaniment sounds is produced in near real-time with a characteristic shake events imparted by the user and is output in audio combination with the currently playing musical media file.

In this way, a user can listen to the musical media file while selectively generating audio signals of percussion instrument sounds that are output along with the playing music, the audio signals including the sounds of striking or shaking a percussion instrument. The ability to use a media player not just as a musical playing device but as a shake-responsive percussion instrument that accompanies a playing media file is referred to herein as “shake jamming” and is a highly desirable feature to be incorporated into traditional portable media players because of the ease and convenience of the shaking metaphor.

A wide variety of traditional percussion instruments are played by musicians through shaking or striking manipulations such that a sound is produced with each shake or strike imparted by the musician. For example, drums, cymbals, bells, tambourines, maracas, and triangles, are all percussion instruments that are played by either shaking or striking. For many such instruments, the hand motions required to sound the instrument is similar to the motion of manually shaking a physical object in the air. Thus, manual shaking is a powerful human metaphor for sounding a percussion instrument. The various exemplary embodiments disclosed herein leverages this metaphor and establishes a new user interface for portable media players by which a user can generate audio representations of musical sounds that accompany the musical content he or she is listening by manually shaking the portable media player itself. More specifically, the various exemplary embodiments enables a user to create audio representations of percussion instrument sounds that are generated and played in response to a user's manual shaking of the portable media player, the musical sounds being output in audio combination with a currently playing musical media file.

In the relevant art, there are many techniques known for electronically generating musical sounds that emulate the sounds of real-world instruments. In some exemplary embodiments, audio representations of musical instrument sounds are digitally sampled and stored in memory for selective access and play. In various exemplary embodiments, audio representations of the musical instrument sounds are modeled mathematically through algorithmic routines. For example, U.S. Pat. No. 4,018,121 to Chowning, which is hereby incorporated by reference, discloses methods by which musical sounds can be generated electronically based upon to the selection and implementation of a number of mathematical parameters. Similarly, U.S. Pat. No. 5,164,530 to Iwase, which is hereby incorporated by reference, discloses methods for generating and varying realistic audio signals of musical instrument sounds electronically based upon the selection and implementation of a number of mathematical parameters including attack, decay, sustain, envelope, and waveform definition parameters.

Similarly, U.S. Pat. No. 5,747,714 to Kniest et al., which is hereby incorporated by reference, discloses methods for generating and varying realistic instrument sounds electronically based upon digital signal processing techniques and employing adjustable parameters such as attack, decay, and sustain as part of the processing and generation of digital music signals. These exemplary methods may employ digital processors that generate simulated waveforms and/or select simulated waveforms from memory and modify such waveforms based upon one or more parameters.

In this way a variety of different musical instrument sounds can be generated in response to an electronic signal and/or under software control, the differing musical instruments sounds representing different real-world instruments and being played such that the sounds are at varying durations, volumes, and tonal quality, based upon parameters used in the various exemplary embodiments. Therefore, the generation of instrument sounds may be performed entirely algorithmically using methods known to computerized music or by digitized versions of actual musical instruments which are stored in memory and then are played back with parametric modifications.

Some methods of digital instrument sound generation employ a physics model of the instrument such that input parameters can be varied (i.e. the physical input applied to the instrument by a person) and the resulting sounds are generated. One technique for physically simulated musical instrument sound generation is disclosed in a paper “Using DSP-Based Parametric Physical Synthesis Models to Study Human Sound Perception” by Perry Cook and Stephen Lakotos, published in the 2003 IEEE Workshop on Applications of Signal Processing to Audio and Acoustics, which is hereby incorporated by reference.

The paper describes Physically Inspired Stochastic Event Modeling (PhISEM) as a digital signal processing algorithm that generates instrument sounds based upon physical models. More specifically, the paper describes a method for the simulation of shakable instruments such as maracas, sleigh bells and tambourines in which sounds are generated by mathematical simulations of particle systems. The method works by mathematically modeling a set of simulated particles within a simulated container and calculating the collisions of the simulated particles to generate sound output events, the sound output events being dependent upon the simulated energy of the particles during the simulated collisions and the physical properties of the simulated particles and the simulated container. Thus by simulating a certain energy input to the system by external activities, the number and intensity of simulated collisions can be modeled and the resulting sounds can be produced.

Sound producing events may be modeled as short exponentially decaying burst of white noise and the system resonance may be modeled using simple resonant filters. In addition, the number of simulated particles, the size of the simulated container, and the material properties of the particles and container can be varied in software to alter the response of the system to simulated external conditions, thereby varying the resulting sound output. Because of the realism provided by the physical modeling methods above, such methods are particularly well suited for use in the various exemplary embodiments as the sound generation means. More specifically, the various exemplary embodiments described herein may employ a method of varying the simulated external conditions of the simulation (i.e. the simulated energy input into the particle model) based upon the timing and magnitude of the detected shaking actions imparted by the user upon the casing of the portable media player.

For example, the magnitude of the energy input into the instrument simulation may be directly proportional to the magnitude of the energy imparted by the user upon the portable media player by shaking it. Analogously, the simulated motion imparted upon the simulated container in the instrument simulation may be directly dependent upon the detected accelerations imparted by the user upon the casing of the portable media player during manual shaking motions. In this way, realistic instrument shaking sounds may be produced in direct response to a user shaking of the portable media player. Such realistic mapping between user shaking input and simulated instrument output provides users with a very natural, intuitive, and satisfying experience.

Where necessary, computer programs, algorithms and routines are envisioned to be programmed in a high level language object oriented language, for example Java (TM) C++, C#, CORBA or Visual Basic (TM).

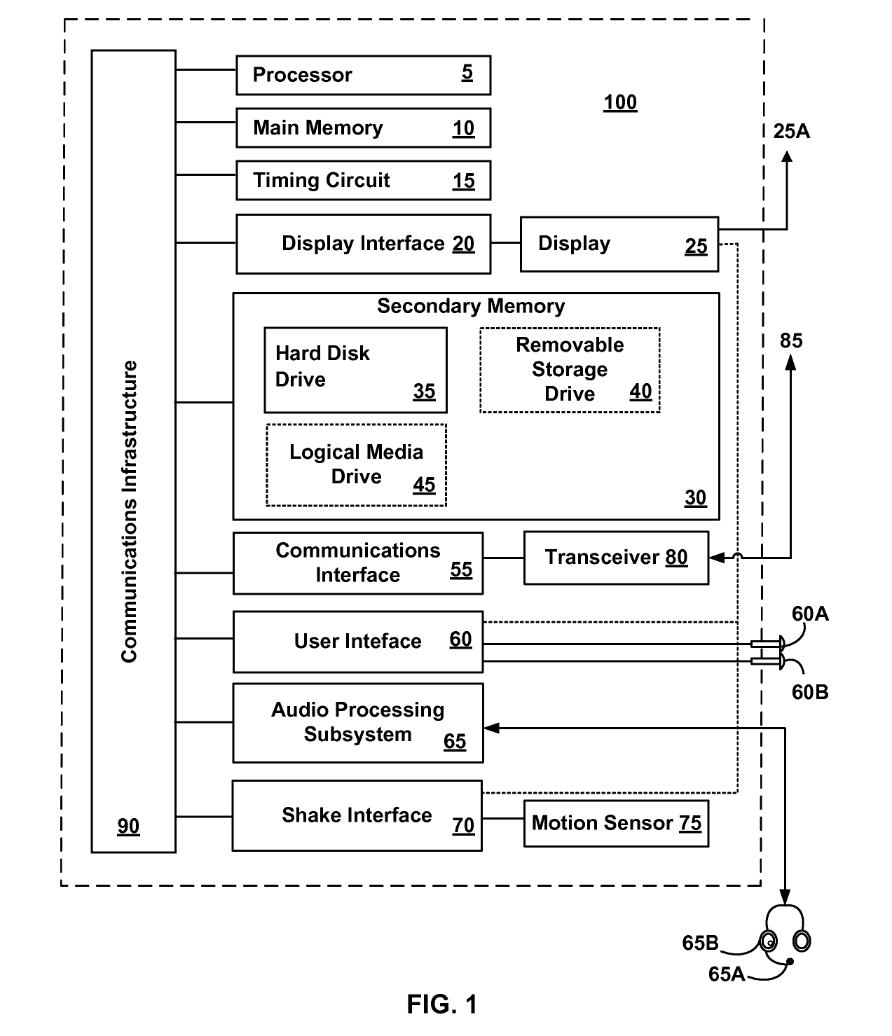

Referring to FIG. 1, a generalized block diagram of a portable media player 100 is depicted. The portable media player 100 includes a communications infrastructure 90 used to transfer data, memory addresses where data items are to be found, and control signals among the various components and subsystems associated with the portable media player 100. A processor 5 is provided to interpret and execute logical instructions stored in the main memory 10. The main memory 10 is the primary general purpose storage area for instructions and data to be processed by the processor 5. The main memory 10 is used in its broadest sense and includes RAM, EEPROM and ROM. A timing circuit 15 is provided to coordinate activities within the portable media player 100 in near real-time and to make time-based assessments of sensor data collected by sensors on board (or interfaced to) the portable media player 100. The processor 5, main memory 10 and timing circuit 15 are directly coupled to the communications infrastructure 90.

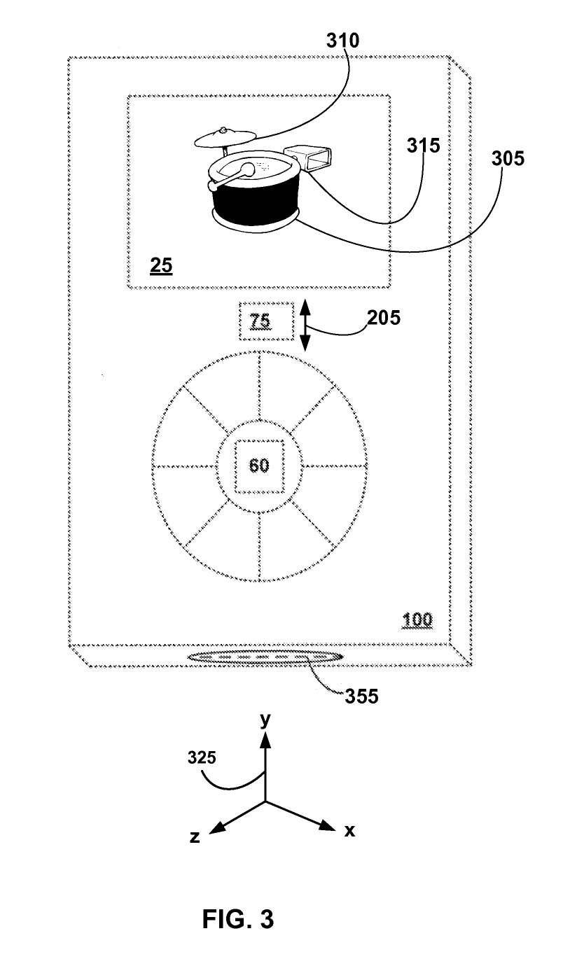

A display interface 20 is provided to drive a display 25 associated with the portable media player 100. The display interface 20 is electrically coupled to the communications infrastructure 90 and provides signals to the display 25 for visually outputting both graphics and alphanumeric characters. The display 25 may for example, display personal photographs access from memory 10 of the portable media player. The display 25 may also, for example, display textual playlists of musical media or graphical images of generated percussion instruments 305,310,315 (FIG. 3) upon the portable media player 100. The display 25 may also, for example, display menus for interacting with software and/or firmware installed of the portable media player 100. The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display (LCD.)

A secondary memory subsystem 30 is provided which houses retrievable storage units such as a hard disk drive 35, a removable storage drive 40, and an optional logical media storage drive 45. One skilled in the art will appreciate that the hard drive 35 may be replaced with flash memory. The secondary memory 30 may be used to store a plurality of media items including but not limited to digitized audio representations of percussion instrument sounds, digital songs, music videos, images, photographs, multi-media presentations, and/or other graphical images. The secondary memory may also store parameterized representations of percussion instrument sounds.

The removable storage drive 40 may be a replaceable hard drive, optical media storage drive or a solid state flash RAM device. The logical media storage drive 45 may include a flash RAM device, an EEPROM encoded with playable media, or optical storage media (CD, DVD).

A communications interface 55 subsystem is provided which allows for standardized electrical connection of peripheral devices to the communications infrastructure 90 including, serial, parallel, USB, Firewire(TM) and network connectivity 85 using a transceiver 80.

The transceiver 80 facilitates the remote exchange of data and synchronizing signals between the portable media player 100 and other devices in processing communications 85 with the portable media player 100.

For networking, the transceiver 80 is envisioned to be of a radio frequency type normally associated with computer networks for example, wireless computer networks based on BlueTooth (TM) or the various IEEE standards 802.1x, where x denotes the various present and evolving wireless computing standards, for example WiMax 802.16 and WRANG 802.22.

Alternately, digital cellular communications formats compatible with for example GSM, 3G and evolving cellular communications standards. Both peer-to-peer (PPP) and client-server models are envisioned for implementation of the various exemplary embodiments. In a third alternative embodiment, the transceiver 80 may include hybrids of computer communications standards, cellular standards and evolving satellite radio standards.

The user interface 60 employed on the portable media play 100 may include a pointing device (not shown) such as a mouse, thumbwheel or track ball, an optional touch screen (not shown); one or more push-button switches 60A, 60B; one or more sliding or circular potentiometer controls (not shown) and one or more switches (not shown.) The user interface 60 provides interrupt signals to the processor 5 that may be used to interpret user interactions with the portable media player 100 and may be used in conjunction with a touch sensitive display 25. The user interface 60 may be configured to enable a user to select from among a plurality of available percussion instruments for use as a current accompaniment instrument, the set of available instruments including for example a drum, cymbal(s), a tambourine, maraca(s), a bell, a triangle, and chimes. The user interface 60 may also be configured to enable a user to adjust the overall relative volume of a playing musical media file and generated audio representations of percussion instrument sounds, the overall relative volume being used to adjust the master volume mix when outputting an audio combination of a playing media file and a series of audio representations of percussion instrument sounds.

For purposes of this specification, the term user interface 60 includes the hardware, firmware and operating software by which a user interacts with the portable media player 100 and the means by which the portable media player 100 conveys information to the user.

In an exemplary embodiment, the user interface 60 may also be coupled to a specialized shake interface 70 which acts in concert with the user interface 60. In an alternate exemplary embodiment, the shake interface 70 operates independently of the more traditional user interface 60.

The shake interface 70 may also monitor interactions with the user interface 60. For example, the shake interface 70 may be used to monitor a user's interaction with the one or more push-button switches 60A, 60B. An interrupt circuit may be incorporated into the hardware as part of the communications infrastructure 90.

The shake interface 70 is operatively coupled to the communications infrastructure 90 and is configured to receive signals from an operatively coupled motion sensor 75. The shake interface 70 may be configured to support one or more motion sensors 75 for detecting various kinds of manually imparted shaking motions on the portable media player 100. The motion sensor 75 may be disposed on a common circuit board which maintains the processor 5 or may be integrated into a case which encompasses the electronics associated with the portable media player 100. In such ways, the motion sensor 75 is coupled to the portable media player 100 such that it detects manual shaking motions imparted by a user upon the portable media player 100 itself. The shake interface 70 may include analog to digital conversion circuitry, signal conditioning circuitry, and/or anti-coincidence circuitry.

The motion sensor 75 is configured to detect when a user deliberately imparts a manual shaking motion upon the portable media player 100 by shaking the device back and forth and/or up and down in his or her hand. Various manual shaking motions may be performed which allows for differentiation of the type of interaction with the portable media player 100 the user is seeking. The manual shaking motions are performed in a manner roughly equivalent to how a user would shake a bottle of salad dressing to mix the bottle's contents.

A variety of motion sensor 75 elements may be employed to detect characteristic shaking motions imparted by the hand of a user upon the casing of a portable media player. However, for cost, size and power consumption considerations, a miniature accelerometer is preferred. For example, Analog Devices, Inc. manufactures many integrated Micro Electro Mechanical System (TM) accelerometers suitable for the various exemplary embodiments described herein. Information regarding the iMEMS (TM) accelerometers may be downloaded from the URL www.analog.com.

One or more accelerometer 75 may be oriented to detect accelerations in one or more degrees of freedom. In certain embodiments, a multi-axis accelerometer 75 may be used. In a simple embodiment, a single axis accelerometer 75 is employed; the axis of detection of the accelerometer being preferably oriented along a long axis of the portable media player 100. In this way, the accelerometer 75 is configured to detect motions imparted upon the portable media player by a user shaking it up and down along generally in parallel to the long axis of the portable media player 100.

An audio processing subsystem 85 is provided and electrically coupled to the communications infrastructure 90. The audio processing subsystem provides for the playback, recording and mixing of digital media, for example, multi or multimedia encoded in any of the exemplary formats MP3, AVI, WAV, MPG, QT, WMA, AIFF, AU, RAM, RA, MOV, MIDI, etc. One skilled in the art will appreciate that the above cited list of file formats is not intended to be all inclusive. Circuits for performing the functions of the audio processing subsystem 85 are well known in the relevant art and are commonly incorporated into personal computer sound cards and like circuitry integrated into portable media players known in the relevant art. The audio processing subsystem 85 may include a microphone input port 65A for input of voice commands and a headphone, headset, ear buds or speaker port for audio output 65B.

Connection of the microphone 65A and/or headphones 65B includes both traditional cable and wireless arrangements such as BlueTooth(TM) are known in the relevant art. In addition, the audio processing subsystem 85 is envisioned to optionally include features such as graphic equalization, volume, balance, fading, base and treble controls, surround sound emulation, and noise reduction.

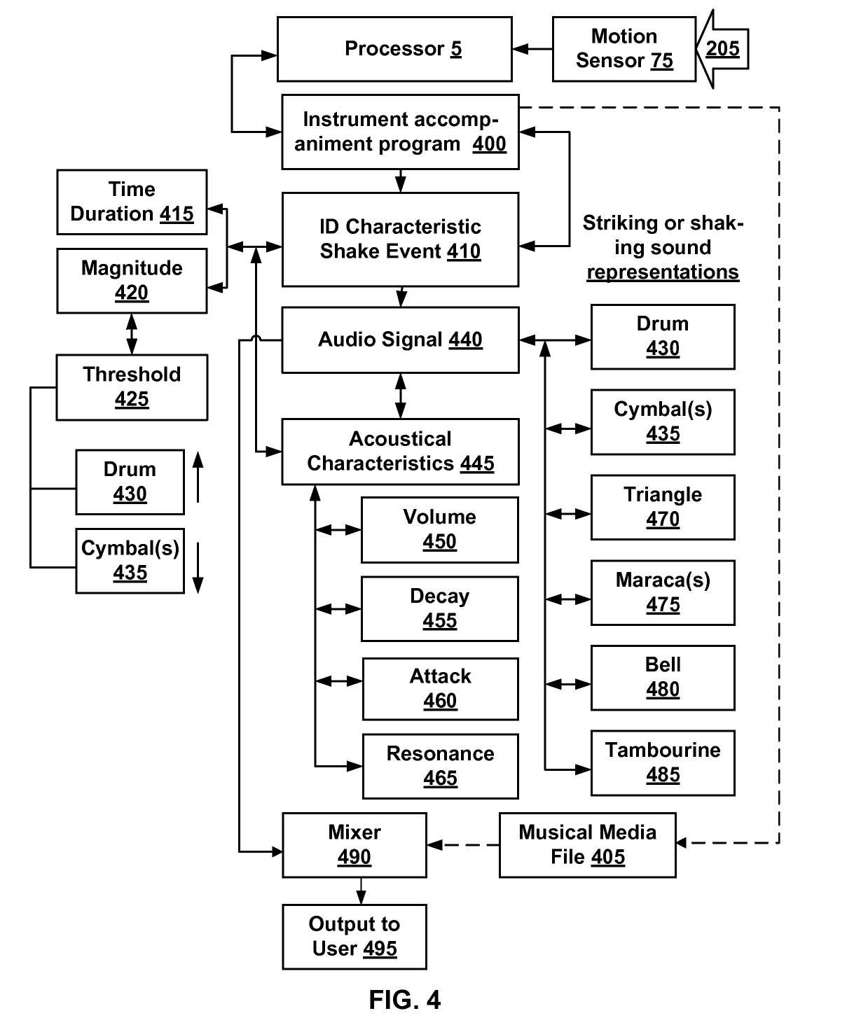

The portable media player 100 includes an operating system, the necessary hardware, software, and/or firmware drivers necessary to fully utilize the devices coupled to the communications infrastructure 90, media playback, mixing and recording applications and at least one instrument accompaniment program 400 (FIG. 4) is operatively loaded into the main memory 10. The instrument accompaniment program 400 may perform or interact with other programs to perform multiple functions, for example, performing the basic media accessing, and playback from a plurality of musical media items stored in the secondary memory 30. The instrument accompaniment program 400 may further, for example, perform the generation and mixing of the audio representations of percussion instrument sounds concurrent with the playing musical media file (i.e. a song or other musical piece.) The instrument accompaniment program 400 may also process or cause to be processed playlists, and/or display images of generated percussion instruments in near real-time to the users manual shaking motions.

In some exemplary embodiments the playlists may be downloaded from external sources over the network 85. The instrument accompaniment program 400 may be configured to control such downloading processes. The instrument accompaniment program 400 may also manage the downloading and storage of new media items into the secondary memory 30 of the portable media player 100. The instrument accompaniment program 400 may also manage the downloading and storage of new percussion instrument sounds as digitized samples, algorithmic routines, and/or parameterized models.

The instrument accompaniment program 400 may also be generally configured to perform the various exemplary embodiments described herein. For example, the instrument accompaniment program 400 is operative to monitor the shake interface 70 by reading the operatively coupled motion sensor 75 and storing data from the motion sensor 75 in memory 10 over time. The instrument accompaniment program 400 may also read data from the timing circuit 15. The instrument accompaniment program 400 processes the time varying signals provided by the motion sensor 75 (which is often an accelerometer) and determines based upon the time varying characteristics of the sensor signals whether or not the user has intentionally imparted manual shaking motions upon the portable media player 100. The intentionally imparted manual shaking motions are used to identify a characteristic shake event(s) which cause the instrument accompaniment program 400 to generate an audio signal representing a percussion instrument which is then mixed with an audio stream of a currently playing media item and audibly output to the user 65A. The generated audio signal representations of percussion instrument sounds is generally the sounds of shaking or striking of a percussion instrument and is generally output in near real-time with the characteristic shake events to which it was responsively produced.

One skilled in the art will appreciate that references to the instrument accompaniment program 400 may be made in both singular and plural form. No limitation is intended by such grammatical usage as one skilled in the art will appreciate that multiple programs, objects, subprograms routines, algorithms, applets, contexts, etc. may be implemented programmatically to implement the various exemplary embodiments.

The instrument accompaniment program 400 may also perform or cause to be performed media item predictive functions, automatically selecting media items for the user that are statistically likely for the user to be in the mood for at a given time. A detailed discussion of a program that performs predictive functions are provided in U.S. patent application Ser. No. 11/267,079 filed on Nov. 3, 2005 to the instant inventor and a common assignee and is herein incorporated by reference in its entirety. Optionally, the portable media player 100 is envisioned to include at least one remote authentication application, one or more cryptography applications capable of performing symmetric and asymmetric cryptographic functions, and secure messaging software (not shown but well understood in the relevant art.)

In various exemplary embodiments, the user may select the simulated percussion instrument that he or she will play in accompaniment with a particular playing media file. The selection may be performed through a menu or other graphical user interface displayed 25 upon the portable media player 100. The percussion instruments that may be selected by the user may include drums, cymbals, tambourines, maracas, bells, chimes, triangles, and/or other common percussion instruments.

In various exemplary embodiments, the instrument accompaniment program 400 automatically selects an appropriate the percussion instrument based upon a stored relational association with the chosen musical media file for current play and/or based upon certain detected qualities of an imparted characteristic shake event. For example, a particular musical media file may be relationally associated with a tambourine. In such a case the instrument accompaniment program 400 may automatically select a tambourine as the simulated instrument for use in the shake-based jamming session when the particular musical media file is being played. Additionally, when the characteristic shake events are of a magnitude below a certain threshold, the output audio signal may represent the sound of shaking a tambourine and when the detected shake events are of a magnitude above a certain threshold, the audio representations of the output instrument sounds may be the sound of striking a tambourine. As such, a user may selectively vary the type of instrument sound based upon a particular quality of the imparted characteristic shake event falling within certain limits or above certain thresholds.

It should also be noted that the instrument accompaniment program 400 is operative to mix the audio signal produced in response to playing a media file (i.e. a song) from memory and the audio signal produced by the simulated percussion instrument sound. In this way, a user may listen to a musical media file (i.e. the song) combined with the user's shake-based accompaniment sounds (i.e., the percussion instrument sounds that are produced in response to imparted characteristic shake event(s)). In some exemplary embodiments, the user may set configuration parameters upon the user interface 60 of the portable media player 100 that sets the overall relative volume of the musical media file signal stream and the simulated percussion instrument audio signal. In such embodiments the user may still vary the volume of percussion instrument sound events by varying the magnitude of imparted shake events, but the overall volume of the percussion instrument sounds may still be adjusted with respect to the playing musical media file. This enables a user to have the audio representations of the instrument accompaniment sounds set at a desirable overall level with respect to the playing musical piece.

In another exemplary embodiment, the user may also adjust the left-right balance of the shake based percussion instrument audio signal, placing the sound within the perceived left-right audio space.

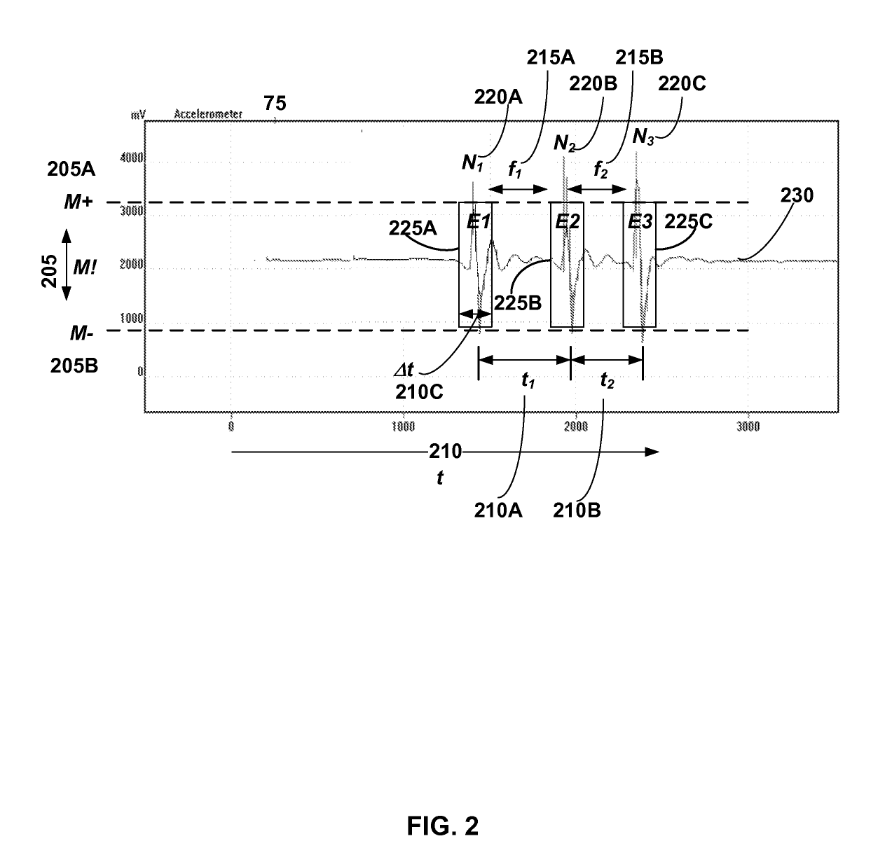

FIG. 2 provides an exemplary signal trace 230 of an accelerometer arranged as a motion sensor 75 suitable for use in the various envisioned embodiments. This particular type of motion sensor 75 provides an analog voltage output signal 230 which varies as a function of the acceleration(s) that the motion sensor 75 is experiencing. For this particular device, a steady state voltage signal of 2000 millivolts (mV) is output from the motion sensor 75 when no accelerations are being detected. When undergoing either a positive or negative acceleration, the voltage output from the accelerometer increases or decreases as functions of the magnitude M! 205 being experienced by the portable media player 100. When sampled over a time domain t 210, various motion dependent parameters may be determined which are useful as a shake jamming user interface.

In general, manual shaking motions may be identified from the time-varying motion sensor data 230 based at least in part upon the presence of a roughly cyclic signal profile that falls within certain bounds and/or exceeds certain limits. Such bounds and/or limits may include frequency parameters f 215, magnitude parameters M 205, count parameters N 220, and/or timing parameters t 210. As shown by the time-varying motion sensor signal 230, a characteristic shaking motion includes a set of repeated acceleration impulses N1, N2, N3 220A,B,C each corresponding with a single manual shake motion imparted by the user. Because the manual shaking motions imparted by the user will generally include a plurality of shake impulses N1, N2, N3 220A,B,C, each being imparted such that it exceeds a certain magnitude thresholds M+, M− 205A,B and collectively being imparted within certain timing t1, t2 210A,B and/or frequency characteristics f1, f2 215A,B, characteristic shake events E1, E2, E3 225A,B,C may be identified based upon the count impulses N1, N2, N3 220A,B,C, magnitude M+, M− 205A,B, timing t1, t2 210A,B, and/or frequency of the acceleration impulses f1, f2 215A,B present in the motion sensor data.

More specifically, the characteristic shake events E1, E2, E3 225A,B,C may be identified based upon the presence of impulse events that exceed a certain magnitude limits, meet certain duration bounds, meet certain frequency bounds, meet certain temporal spacing requirements, and/or contain a count of impulses that falls within certain numerical bounds.

Thus, an analysis of the time-varying acceleration profile of motion data 230 may be performed by the instrument accompaniment program 400 to determine if a manual shaking motion has been imparted by the user upon the portable media player 100 based upon magnitude M! 205; frequency f1, f2 215A,B; timing t1,t2 210A,B; and/or count characteristics N1, N2, N3 220A,B,C. In general, this analysis includes an identification of impulse events E1, E2, E3 225A,B,C and a determination as to whether the magnitude M! 205 of the impulse events, frequency of impulse events, temporal spacing of impulse events, and/or numerical count of impulse events meet certain bounds and/or exceed certain limits.

In some exemplary embodiments, the instrument accompaniment program 400 is configured to identify a characteristic shake event 225 being imparted by a user when a portion of the time varying motion sensor signal 230 meets a certain magnitude M! 205 and/or temporal bounds Δt 210C. For example, a characteristic shake event E 225 may be identified when a portion of the time varying sensor signal 230 exceeds both a positive and negative magnitude threshold M+, M− 205A,B within a certain time duration Δt 210C. In such embodiments, the instrument accompaniment program 400 may be configured to output an audio representation of the sound of striking or shaking a percussion instrument in response to the characteristic shake event E 225 and in near-real-time with the identified characteristic shake event E 225. This gives the user a convincing illusion that he or she generated a simulated sound on a real physically responsive musical instrument.

Furthermore, in some exemplary embodiments the audio output quality of the striking or shaking sound representation may be dependent upon the magnitude M! 205 and/or timing t 210 of sensor signal 230 of the characteristic shake event E 225. For example, the volume of the sound of striking or shaking the percussion instrument may be dependent upon the peak or average magnitude M! 205 of the sensor signal 230 of the characteristic shake event E 225. Similarly, the volume of the sound of striking or shaking the percussion instrument may be dependent upon the duration of the sensor signal 230 of the characteristic shaking event.

In general, one or more motion dependent parameters may be used to vary the sound characteristics of the generated sound of striking or shaking a percussion instrument. More specifically, the detected magnitude M! 205 of impulse events, the detected duration Δt 210C of characteristic shake events E1, E2, E3 225A,B,C the detected frequency between impulse events f1, f2 215A,B, the detected count N1, N2, N3 220A,B,C of repeated impulse events E1, E2, E3 225A,B,C, and/or the detected timing of impulse events t1, t2 210A,B may be used, at least in part, to control the audio output quality of the generated percussion instrument sound representation(s.)

In an exemplary embodiment, the detected magnitude M! 205 of the impulse events and/or the detected duration of characteristic shake events E1, E2, E3 225A,B,C may be used, at least in part, to control certain musical acoustical characteristics of the generated percussion instrument sound representation including the outputted volume, decay, attack and resonance.

Additionally, the various motion dependent parameters may be determined in multiple geometric axes 325 (FIG. 3) which may be useful for discriminating against unintentional accelerations detected by the motion sensor 75 from being processed by the processor 5. In addition, ambient accelerations imparted due to the constant force of gravity and/or due to a moving reference frame of the user may be filtered from and/or otherwise differentiated from the intentionally imparted shaking motion signal 230 data using traditional signal processing techniques.

With respect to the identification of a single characteristic shake event N1, N2, or N3 220A,B,C, such an event can generally be identified as a rapidly changing acceleration signal that exceeds a certain upper threshold M+ 205A and exceeds a certain lower threshold M− 205B, and does both within a certain small time period Δt 215C. The threshold values used for M+, M−, 205A,B and Δt 215C may vary and are generally selected based upon the size and weight of the portable media player itself and the characteristics of the accelerometer employed. For the system that generated the signal profile 230, the event duration Δt 210C was defined as 100 milliseconds, although smaller time intervals may be used for greater impulse event discrimination. The upper threshold M+ 205A is approximately 3000 mV; the lower threshold M− 205B is approximately 1000 mV. In some exemplary embodiments a duration t1,t2 210A,B and/or Δt 210C may be determined for a characteristic shake event E 225 the duration being the time during which the magnitude of the signal peaks exceeds one or more thresholds before decaying to a level that does not exceed the thresholds M+, M−, 205A,B.

In some exemplary embodiments, a magnitude M! 205 is determined for a characteristic shake event E 225, the magnitude M! 205 being an average of the absolute value of the signal levels over the duration of the characteristic shake event E 225. Alternately, the magnitude M! 205 may be determined from the difference between the maximum positive peak M+ 205A and maximum negative peak M− 205B over the duration of the characteristic shake event. In some exemplary embodiments the magnitude M! 205 may be determined as the absolute value of the maximum peak detected over the duration of the characteristic shake event.

As the acceleration (motion) signals 230 are processed over time starting from t=0 and extending forward along time axis 210, there are no characteristic shaking events detected by the instrument accompaniment program 400 until the time profile reaches approximately 1400 milliseconds in time t 210. At this time, a positive voltage transient exceeds the upper threshold M+ 205A. This voltage transient corresponds with a user moving the portable media player 100 with sufficient force to exceed the upper threshold M+ 205A of acceleration. A negative voltage transient which exceeds the lower threshold M− 205B immediately following the positive voltage transient. This corresponds with the user moving the portable media player 100 with sufficient force in the opposite direction to exceed the lower threshold M− 205B. Both thresholds are crossed within a time span of less than approximately 100 milliseconds (i.e. within the limits of the defined Δt 210C). This means that the user imparted a sufficient acceleration upon the portable media player 100 in a first direction to exceed the positive threshold M+ 205A and then immediately reversed direction and within the required time duration Δt 210C, imparted a sufficient acceleration upon the portable media player 100 in the reverse direction to exceed the negative threshold M− 205B.

As such, the instrument accompaniment program 400, may determine that the voltage transients exceeded both the positive M+ 205A and negative thresholds M− 205B within certain predefined time duration Δt 210C (e.g. 100 milliseconds), to elucidate that a characteristic shake event E 225 has occurred. The instrument accompaniment program 400 then generates and outputs an audio signal representing the sound of shaking or striking a percussion instrument in near-real-time relative to the detected shaking motions; the percussion audio signal being output in audio combination with a currently playing media file. By near real-time it is meant that to the user, it is perceived as approximately simultaneous with the imparted characteristic shake event(s) E 225. Ideally a time delay of less than 50 milliseconds after the completion of the shaking motions, for such a delay sufficiently small such that it is generally perceived as near real-time to a user.

Depending upon the profile of the shake motion and the type of the audio signal generated, longer delays may be used so long as the sound is perceived as approximately simultaneous with the shaking event by the user.

The instrument accompaniment program 400 may further process the data, identifying subsequent impulse events N2, N3, . . . Nn, in a similar manner, and output additional audio representations of the shaking or striking of a percussion instrument. In this way, the user who imparted the three characteristic shake events N1, N2, and N3 220A,B,C, would hear three distinct and separate sounds events, each sound event being the sound of shaking or striking a percussion instrument; each sound event being output in near real-time with its corresponding characteristic shake event.

In addition, each sound event is output in audio combination with the seamlessly playing media file, thus sounding to the user as an instrumental accompaniment with the playing media file. Thus, a user may listen to the musical media file as it plays over time and selectively impart a series of characteristic shake events upon the media player in time with the music, the series of characteristic shake events resulting in an instrumental accompaniment produced by the portable media player 100 in which a percussion instrument is repeatedly sounded in near real-time with each characteristic shake event E 225.

It should be noted that while positive threshold M+ 205A and negative threshold M− 205B are shown in FIG. 2 to be equally distant from the nominal no-acceleration signal profile 230, this need not be the case in all embodiments. In some exemplary embodiments, a larger threshold may be employed in one direction as compared to the opposite direction. In fact, this is often desired because a human user generally imparts greater acceleration upon an object he is shaking when extending arm muscles as compared to when flexing arm muscles during a reciprocating characteristic shaking motion.

In some exemplary embodiments, a sequence of characteristic shake events N1, N2, and N3 220A,B,C may be specifically required by the instrument accompaniment program 400 in order for a user to indicate a particular intention to the portable media player 100. For example, the instrument accompaniment program 400 may be configured to determine that a characteristic shake event E1 225A has been imparted by the user only if a particular sequence of characteristic shake impulses N1, N2, N3 220A,B,C events are detected in the sensor signals 230. For example, in some exemplary embodiments, the portable media player 100 may be configured such that the imparted impulses N1, N2, N3 220A,B,C are used to determine if the user is deliberately shaking the portable media player 100; for example, if three or more characteristic single-shake acceleration impulses are detected in sequence within the acceleration data, each single-shake acceleration profile being separated by a certain minimum amount of time (for example 250 milliseconds) t1, t2 210A,B, and all three of the single-shake acceleration profiles being imparted upon the portable media player 100 within a certain maximum amount of time (e.g., 2000 milliseconds), each of the three characteristic single-shake acceleration impulses N1, N2, N3 220A,B,C indicating a intentional user shake as a result of exceeding the positive M+ 205A and negative acceleration threshold M− 205B.

In this way, deliberate shaking events may be more easily distinguished from noise and/or unintentional movements of the portable media player 100. For example, the portable media player 100 may be configured such that musical instrument accompaniment sound representations do not begin being output in audio combination with a playing media file until at least three characteristic shake events E1, E2, E3 225A,B,C are detected with certain timing parameters as described above. Thereafter, the audio signals are output in response to each characteristic shake event E 225. In this way, a user makes his or her intention clear to the system that he or she is deliberately performing a musical accompaniment activity (i.e. by imparting three characteristic shakes in a characteristic manner) before the percussion instrument audio representations begin being output in the audio stream. This avoids spurious sounds being imparted when not desired by the user.

Referring to FIG. 3, the various exemplary embodiments described herein, leverages an intuitive shaking metaphor and establishes a unique user interface for a portable media player 100 in a user can selectively add audio signals to a playing musical media file using an intentional manual shaking motion 205. This exemplary embodiment of the portable media player 100 includes a display 25, a finger manipulatable user interface 60 and an external connectivity port 355 which is coupled to the communications interface 55. As previously discussed, the motion sensor 75 may provided with multi-axis 325 detection capabilities as may be envisioned for the various exemplary embodiments.

In an exemplary embodiment, the portable media player 100 is equipped with an accelerometer type motion sensor 75. Intentional manual shaking motions 205 imparted on the portable media player 100 by the user cause motion signals to be detected by the accelerometer 75. The motion signals are processed by the instrument accompaniment program 400 (FIG. 4) to generate an audio signal representing the striking or shaking of a percussion instrument 305. For example, the sound may be the sound of striking a drum 305 or cymbal 310, or shaking of a bell 315. In some such exemplary embodiments, the volume and/or other audio quality of the audio signals is dependent upon how the user shook the media player (i.e. the magnitude and/or timing duration of the corresponding shake event as described above.) Thus, if the audio signal is representative of a drum, a shake event with a larger magnitude may result in a louder drum sound and a shake event with a lesser magnitude may result in a softer drum sound. In an embodiment, the type of percussion audio signal that is generated is determined by user selection through a preferences menu, setup program or configuration program. In another exemplary embodiment, the type of percussion instrument to be generated as an audio signal is determinable by the magnitude M! 205, duration t 210, frequency f 215 and/or number of impulses N 220 the user has intentionally imparted as provided in the discussion for FIG. 2.

The generated audio signal is then mixed with an audio signal stream of a currently playing musical media file in near real-time. In an embodiment, a graphical image of the percussion instrument generated 305, 310, 315 is retrieved from the memory 30 and outputted to the display 25. The graphical image 305, 310, 315 provides the user feedback on the type of percussion instrument selected to be generated.

FIG. 4 provides an exemplary operational block diagram illustrating the functionality of the instrument accompaniment program 400. In an exemplary embodiment, a motion sensor 75 detects motion signals 230 in response to a user imparted shaking motion 205 on the portable media player 100. The motion signals 230 are processed by the processor 5 using the instrument accompaniment program 400 to determine if the detected motions signals are characteristic of intentional manual shaking motions.

A musical media file 405 may already be playing on the portable media player 100 or in a queue or playlist to play to a user. From the received motion sensor signals 230, the instrument accompaniment program 400 identifies the characteristic shake event E 225 which triggers the generation of the audio signal 440. The audio signal 440 is generally a discrete event corresponding with the sound of striking or shaking a percussion instrument, for example imparting a single strike upon a drum or imparting a single shake upon a tambourine.

The instrument accompaniment program 400 may use the time duration 415 and/or magnitude of the characteristic shake event 410 to determine whether or not to generate the audio signal 440 of the striking or shaking sound representations. For example, only shake events above a certain magnitude may result in the production of the audio signal 440.

In some exemplary embodiments, the instrument accompaniment program 400 uses the time duration 415 and/or magnitude of the characteristic shake event 410 to determine the type of audio signal 440 to use in the striking or shaking sound representations. In an exemplary embodiment, one or more thresholds 425 may be used to trigger one of a plurality of certain audio signal representations 440. For example, a first audio signal representation may be triggered in response to characteristic shake event 410 of less than a certain threshold level and a second audio signal representation may be triggered in response to a characteristic shake event of equal to or greater than the certain threshold level. For example, the magnitude of an identified characteristic shake event 410 may be used to generate an audio signal representing cymbals 435 if the magnitude is less than a established threshold 425 and generating an audio signal representing a drum 430 if the magnitude of the identified characteristic shake event 410 is equal to or greater than the established threshold 425.

Within the established threshold limits 425, the volume 450 of the generated audio signals of the particular percussion instrument may be varied depending upon the magnitude of the detected shake event. In this way, a user of the example embodiment can selectively impart drums sounds of varying magnitude 420 as well as cymbal sound representations 435 of varying magnitude 420 by simply imparting shake events upon the portable media player of varying magnitudes 420, some of which are less than the established threshold 425 and some of which are greater than the established threshold 425.

The audio signal 440 generated may represent a plurality of percussion instruments including a drum 430, cymbal(s) 435, a triangle 470, maraca(s) 475, a bell 480, and/or a tambourine 485. The generation of the audio signal 440 may be performed direct playback of a prerecorded sound or synthesized using for example a Musical Instrument Digital Interface (MIDI) compatible device and/or software.

In another exemplary embodiment, the audio signal 440 may be generated based upon a parametric physically inspired digital signal processing model in which a real physical system is modeled so as to produce the resulting sound. For example, the instrument accompaniment program 400 may employ Physically Inspired Stochastic Event Modeling (PhISEM) algorithms to synthesize sounds that are created based upon the simulated motion of physical particle systems as described previously. As such, the motions of simulated particles are computed based at least in part upon the magnitude 420 of the physical motion imparted by the user upon the portable media player 100. In this way, the resulting sound will be a realistic physical representation of the shaking motion 205 imparted by the user. As such, the harder and/or faster that the user shakes the portable media player 100, the faster the simulated particles will be moved about in the simulation, and thus the faster and/or louder the resulting audio signal 440 that will be generated.

In an exemplary embodiment, certain acoustical characteristics 445 of the generated audio signal 440 may be adjusted by the instrument accompaniment program 400 in dependence at least in part upon by the time duration 415 and/or magnitude 420 associated with the identified characteristic shake event 410 to which it corresponds. The configurable acoustical characteristics 445 includes the volume 450, decay 455, attack 460 and/or resonance 465 of the audio signal 440 to be mixed 490 with the currently playing musical media file 405. The volume 450 and attack characteristics are generally dependent of the magnitude 420 of the identified characteristic shake event 410; the decay 455 is generally dependent on the time duration 415 of the identified characteristic shake event 410 although it may also be dependent upon the magnitude 420; and the resonance 465 being generally dependent on both the time duration 415 and magnitude 420 of the identified characteristic shake event 410.

The generated audio signal 440 is mixed 490 with the audio stream of the currently playing musical media file 405 and outputted to the user 495. In some exemplary embodiments all four of the volume 450, decay 455, attack 460, and resonance 465 are dependent at least in part upon the magnitude 420 of the identified characteristic shake event 410 (i.e. on how hard the user imparted a shake upon the portable media player 100.)

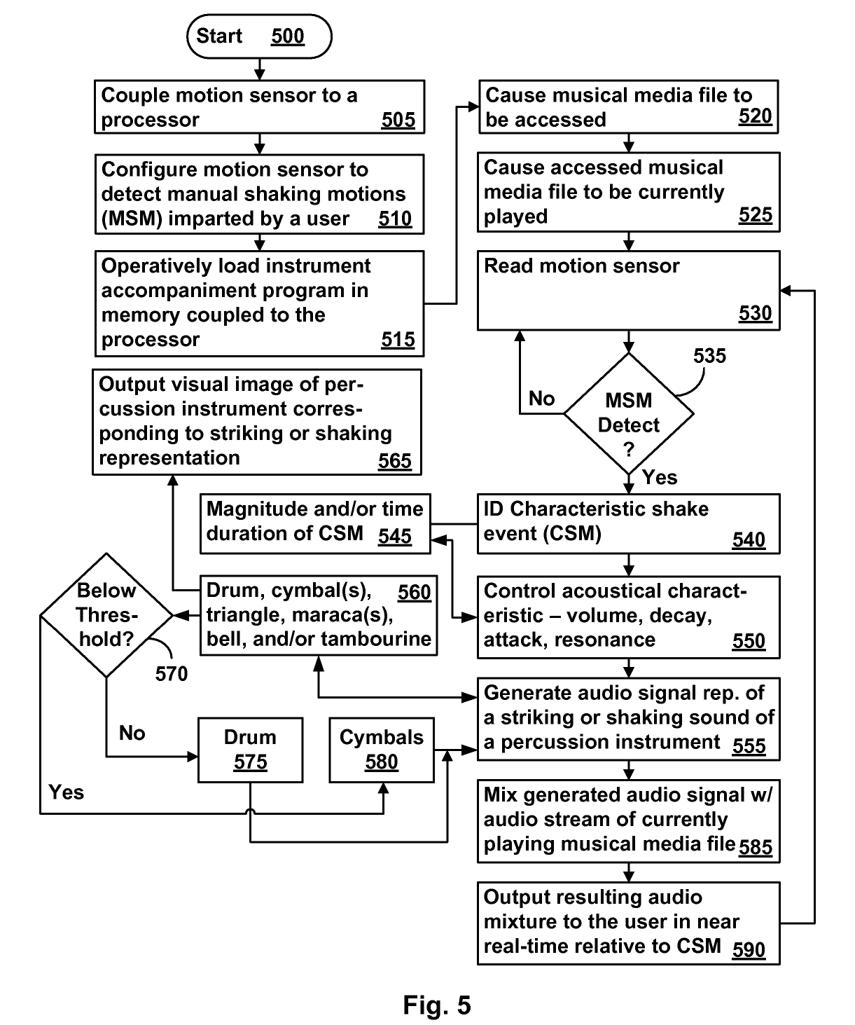

FIG. 5 depicts an exemplary process flow chart for implementing one or more of the various exemplary embodiments. The process is initiated 500 by operatively coupling a motion sensor to a processor associated with a portable media player 505. The motion sensor is then configured to detect manual shaking motions (MSM) imparted on the portable media player by a user 510. An instrument accompaniment program is then loaded into a memory coupled to the processor 515. Upon execution, the instrument accompaniment program causes a musical media file to be accessed from memory 520. The accessed musical media file is then currently played to the user 525.

Once executed, the instrument accompaniment program periodically reads the motion signals sent from the motion sensor 505. The instrument accompaniment program determines if an intentional MSM has been detected. If an unintentional detection occurs, the instrument accompaniment program ignores the motion signal and continues monitoring the motion sensor for an intentional MSM 535. If a MSM is detected, the instrument accompaniment program processes the MSM to identify a characteristic shake event (CSM) 540. In an exemplary embodiment, the instrument accompaniment program determines the magnitude and/or the time duration associated with the identified CSM 545.

In another exemplary embodiment, the instrument accompaniment program may control certain acoustical characteristics 550 in dependence on the magnitude and/or time duration 545 associated with the identified CSM 540. A plurality of acoustical characteristics may be controlled including the volume, decay, attack and resonance 550 in dependence on the magnitude and/or time duration 545 associated with the identified CSM 540.

The instrument accompaniment program then generates an audio signal representation of a striking or shaking sound of a percussion instrument 555. A plurality of distinct audio signal representations may be generated by the instrument accompaniment program including audio signal representations of drums, cymbals, triangles, maracas, bells, and/or tambourines 560. Within a particular audio signal, the instrument accompaniment program may vary the volume, attack, decay, or resonance, of the sound of striking or shaking that particular instrument representation 550. In this way, a user may play a drum 560, for example, with volume and/or other audio characterizes of each generated and output drum sound being dependent upon the magnitude and/or duration 545 of each corresponding imparted CSM 540.

In an exemplary embodiment, a visual image of the percussion instrument corresponding to the striking or shaking audio signals being generated is output on a display associated with the musical media player 565.

In another exemplary embodiment, a threshold may be established for determining the audio signal representation 555 to be generated. If the identified CSM 540 is above the established threshold 570, an audio signal representing cymbals 580 is generated. Alternately, if the identified CSM 540 is less than or equal to the established threshold 570, an audio signal representing a drum is generated 575.

In another exemplary embodiment, a threshold 570 may be established for determining the audio signal representation 555 to be generated. If the identified CSM 540 is equal to or greater than the established threshold 570, an audio signal representing striking a drum 560 is generated. Alternately, if the identified CSM 540 is less than the established threshold 570, an audio signal representing a striking cymbals 560 is generated.

The generated audio signal 555 is then mixed with an audio stream of the currently playing musical media file 585 and the resulting audio mixture is then outputted to the user in near real-time relative to the identified CSM 590.

The foregoing described exemplary embodiments are provided as illustrations and descriptions. They are not intended to limit an inventive scope to any precise form described. In particular, it is contemplated that functional implementation of the instrument accompaniment program described herein may be implemented equivalently in hardware, software, firmware, and/or other available functional components or building blocks. Other variations and embodiments are possible in light of above teachings, and it is not intended that this Detailed Description limit the scope of inventive embodiments, but rather by the Claims following herein.

What is claimed:

1. A shake jamming portable media player comprising:
a processor;
a memory functionally coupled to the processor;
a motion sensor functionally coupled to the processor and configured to detect manual shaking motions imparted by a user on the portable media player;
an instrument accompaniment program operatively loaded into the memory including instructions executable by the processor to;
cause a musical media file to be accessed from the memory;
cause the accessed musical media file to currently play;
identify a characteristic shake event from the detected manual shaking motions;
generate an audio signal representing a striking or shaking sound of a percussion instrument in dependence on the identified characteristic shake event;
mix the generated audio signal with an audio stream of the currently playing musical media file; and,
output a resulting audio mixture to the user in near real-time relative to the identified characteristic shake event.

2. The shake jamming portable media player according to claim 1 wherein the motion sensor is physically coupled to the portable media player.

3. The shake jamming portable media player according to claim 1 wherein an audio signal is generated for each identified characteristic shake event.

4. The shake jamming portable media player according to claim 1 wherein an acoustical characteristic of the generated audio signal is dependent on one of; a magnitude of the identified characteristic shake event, a time duration of the identified characteristic shake event and any combination thereof.

5. The shake jamming portable media player according to claim 4 wherein the acoustical characteristic is one of; volume, decay, attack and resonance.

6. The shake jamming portable media player according to claim 5 wherein the volume is dependent upon the magnitude of the identified characteristic shake event.

7. The shake jamming portable media player according to claim 5 wherein the decay is dependent upon the time duration of the identified characteristic shake event.

8. The shake jamming portable media player according to claim 5 wherein the attack is dependent upon the magnitude of the identified characteristic shake event.

9. The shake jamming portable media player according to claim 5 wherein the resonance is dependent upon one of; the magnitude, the time duration and any combination thereof of the identified characteristic shake event.

10. The shake jamming portable media player according to claim 4 wherein the generated audio signal is contingent upon the magnitude of the identified characteristic shake event.

11. The shake jamming portable media player according to claim 1 wherein the generated audio signal is a striking or shaking sound representation of one of; a drum, a cymbal, a triangle, a maraca, a bell, a tambourine and any combination thereof.

12. The shake jamming portable media player according to claim 11 wherein the instrument accompaniment program further includes instructions to output a visual image of the percussion instrument corresponding to the current striking or shaking sound representation being generated.

13. The shake jamming portable media player according to claim 10 further including instructions executable by the processor to generate a first audio signal if the magnitude of the identified characteristic shake event is below a predefined threshold and generate a second audio signal if the magnitude of the identified characteristic shake event is equal to or greater than the predefined threshold.

14. The shake jamming portable media player according to claim 13 wherein the first audio signal is a striking or shaking sound representation of a drum and the second audio signal is a striking or shaking sound representation of a cymbal.

15. The shake jamming portable media player according to claim 1 wherein the characteristic shake event corresponds with the user imparting a single up-down motion generally in parallel to a long axis of the portable media player.

16. The shake jamming portable media player according to claim 1 wherein the characteristic shake event is identified based at least in part upon the motion sensor data exceeding both a positive and negative magnitude threshold within a predefined timeframe.

17. A method for providing a shake jamming portable media player comprising:
functionally coupling a motion sensor to a processor associated with the portable media player;
configuring the motion sensor to detect manual shaking motions imparted by a user on the portable media player;
operatively loading into a memory coupled to the processor an instrument accompaniment program including instructions executable by the processor for;
causing a musical media file to be accessed from the memory;
causing the accessed musical media file to currently play;
identifying the imparted characteristic shake event from the manual shaking motion signals;
generating an audio signal representing a striking or shaking sound of a percussion instrument in dependence on the identified characteristic shake event;
mixing the generated audio signal with an audio stream of the currently playing musical media file; and,
outputting a resulting audio mixture to the user in near real-time relative to the identified characteristic shake event.

18. The method according to claim 17 further including instructions executable by the processor for controlling an acoustical characteristic of the generated audio signal in dependence on one of; a magnitude of the identified characteristic shake event, a time duration of the characteristic shake event and any combination thereof.

19. The method according to claim 18 wherein the acoustical characteristic is one of; volume, decay, attack and resonance.

20. The method according to claim 19 further including instructions executable by the processor for controlling the decay in dependence upon the time duration of the identified characteristic shake event.

21. The method according to claim 19 further including instructions executable by the processor for controlling the attack in dependence upon the magnitude of the identified characteristic shake event.

22. The method according to claim 20 further including instructions executable by the processor for generating a first audio signal if the magnitude of the identified characteristic shake event is below a predefined threshold and generating a second audio signal if the magnitude of the identified characteristic shake event is equal to or greater than the predefined threshold.

23. The method according to claim 22 wherein the first audio signal is a striking or shaking sound representation a drum and the second audio signal is a striking or shaking sound representation of a cymbal.

24. A computer program product for a shake jamming interface embodied in a tangible form comprising instructions executable by a processor associated with a portable media player to:
cause a musical media file to be accessed from a memory coupled to the processor;
cause the accessed musical media file to be currently played;
identify a user imparted characteristic shake event from detected manual shaking motion signals received from a motion sensor functionally coupled to the processor;
generate an audio signal representing a striking or shaking sound of a percussion instrument in dependence on the identified characteristic shake event;
mix the generated audio signal with an audio stream of the currently playing musical media file; and,
output a resulting audio mixture to the user in near real-time relative to the identified characteristic shake event.

25. The computer program product according to claim 24 further including instructions executable by the processor to output a first audio signal if the magnitude of the identified characteristic shake event is below a predefined threshold and output a second audio signal if the magnitude of the identified characteristic shake event is equal to or greater than the predefined threshold.

26. The computer program product according to claim 25 wherein the first audio signal is a striking or shaking sound representation of a drum and the second audio signal is a striking or shaking sound representation of a cymbal.

27. The computer program product according to claim 24 further including instructions executable by the processor for controlling an acoustical characteristic of the output in dependence on one of; a magnitude of the identified characteristic shake event, a time duration of the characteristic shake event and any combination thereof.

28. The computer program product according to claim 27 wherein the acoustical characteristic is one of; volume, decay, attack and resonance.

29. The computer program product according to claim 24 wherein the tangible form is one of; a logical media, a magnetic media and an optical media.
